(19) United States
(12) Patent Application Publication
(10) Pub. No.: US 2017/0262185 A1
(43) Pub. Date: Sep. 14, 2017

(54) ACTIVE DATA-AWARE STORAGE MANAGER

(71) Applicant: DataGravity, Inc., Nashua, NH (US)

(72) Inventors: Paula Long, Amherst, NH (US); Eric K. McCall, Peterborough, NH (US); Kannan Sasi, Pelham, NH (US); David D. Siles, Apollo Beach, FL (US); Damon Hsu-Hung, Sudbury, MA (US); Eric Sondhi, Tyngsboro, MA (US)

(21) Appl. No.: 15/451,674

(22) Filed: Mar. 7, 2017

Related U.S. Application Data
(60) Provisional application No. 62/305,011, filed on Mar. 8, 2016.
(60) Provisional application No. 62/340,219, filed on May 23, 2016.

(51) Int. Cl. G06F 3/06

(52) U.S. Cl. CPC G06F 3/0605; G06F 3/0665; G06F 3/0685; G06F 3/065

(57) ABSTRACT

A data-aware storage system having an intelligence module that classifies data objects or data streams, and cooperates with a primary storage module to assign storage services tailored to each class.

### CROSS-REFERENCE TO RELATED APPLICATION

This application claims priority to co-pending U.S. Patent Application Ser. No. 62/305,011 filed Mar. 8, 2016 entitled “Active Data-Aware Provisioning Technology”, and co-pending U.S. Patent Application Ser. No. 62/340,219 filed May 23, 2016 entitled “Active Data-Aware Provisioning Technology”, and is related to co-pending U.S. patent application Ser. No. 14/499,886 filed Sep. 29, 2014 entitled “System and Method of Data Intelligent Storage” the entire contents of each of which are hereby incorporated by reference.

### BACKGROUND

Technical Field

This patent application relates to data-aware storage systems.

Background Information

Most data storage systems embody tradeoffs between performance, capacity, reliability, price, and other factors. Heterogeneous systems employ diverse types of storage to optimize these tradeoffs, which succeeds to the extent that the tradeoffs are nonlinear. For example, a few fast disks combined with many cheap disks can be nearly as fast as using fast disks alone, and nearly as cheap as using cheap disks alone.

Tiering generally refers to heterogeneous systems wherein data is placed on one type of storage versus another. Caching can be viewed as a heterogeneous system wherein data temporarily resides on one type of storage and is then moved to another type of storage. These techniques, which are all well-known in the art, are sometimes referred to as Hierarchical Storage Management (HSM). An assumption of hierarchy typically underlies these techniques, where storage tier 0 is “better” in terms of performance and costlier in every way than storage tier 1, which is better in every way and costlier in every way than storage tier 2, and so on.

### SUMMARY

The storage management systems and methods described herein are data-aware, and consider more than performance criteria in how they manage data. In particular, data is mapped to appropriate storage entities based on a classification for the data that is determined from analytics. A set of policies is also determined that define how data in a particular class is to be assigned, or mapped, to appropriate storage entities.

The approach provides a number of unique advantages. The analytics provides in-depth pattern matching, search and discovery, to automatically analyze data and assign it to a class, for example, a sensitive data class that may be at risk and must be protected. Policies defined for the data class are then applied to ensure the data is housed in a storage entity appropriate for the class.

In one embodiment, an active data-aware storage management system includes at least a data classifier and a mapper. The data classifier and mapper have access to data stored in one or more logical storage entities.

The logical storage entities may include local or on-premesis storage arrays, network attached storage, storage appliances (remote or local), or data storage services such as public or private cloud services, or any other storage entity accessible to the system.

The classifier of the active data-aware storage management system serves as way to intelligently classify data of many types, including data objects, data streams, or even data that may be embedded in other structures such as virtual machine files. The data-aware classifier can potentially recognize a wide variety of characteristics of the data, limited only by available computing power rather than hardcoded conventions.

In some embodiments, the data-aware classifier may discover characteristics of the data by analyzing its content, encoding schemes, format, by monitoring access patterns, sampling the behavior of a data object or data stream, observing relationships between objects, and so on. Such a classifier may also determine that some objects have sensitivity (e.g., they contain information which should be protected, or to which access should be restricted, etc.), or functional importance (e.g., system files), that data objects have semantic importance (e.g., an annual report), or that some data objects have both functional and semantic importance (e.g., an index), and that while some objects aren't important at all they should be given high retention guarantees (e.g., an old email).

The classifier may also infer relationships between these characteristics. In one instance instance, relating content attributes, workload attributes, and schedule attributes might reveal that objects containing the keyword “virtualization” are write-intensive on weekdays.

The mapper associates or maps a data class to a logical data storage entity, which is to say that it intelligently selects a set of policies that apply to that data class, and identifies a logical storage entity (such as an on-premise storage subsystem or remote data storage service, etc.) that matches the desired policies to at least some degree. The mapping function is responsible for computing the optimality of a storage entity for a data class. An implementor or user may be responsible for defining the policies, such as in the form of an objective function or more simply, in the form of a static graph relating appropriate classes to appropriate storage entities.

An optional data mover may operate on the results of the mapping function to enact movement of classified data from one storage entity to another. In particular, the data mover may systematically perform subsequent analytics on the If a policy violation is found, or some other indication is evident that a different mapping of logical storage entit(ies) would be a better match, then the mapping for that data is changed by moving the data.

An optional provisioner provides a way to create diverse storage entities, custom-tailored to each data class determined by the classifier. Provisioned storage entities could then be used by the mapper and/or mover.

The data-aware provisioner can define the properties of storage entities (such as storage sub-systems or storage services), which it then uses to assemble custom logical storage entities suitable for the data classes discovered by the classifier. Such elements might include a variety of cache intake policies, a variety of cache eviction policies, a variety of RAID policies, a variety of priority policies, a variety of protection policies, a variety of compliance policies, and so on.

Accordingly, the provisioner operates under a novel definition of provisioning: to provision a storage service not merely to allocate resources, but to dynamically instantiate a selected set of policies into a logical storage entity that is appropriate for an observed data class. Such instantiation may encapsulate the allocation of storage resources or other aspects of conventional storage provisioning.

### BRIEF DESCRIPTION OF THE DRAWINGS

The description below refers to the accompanying drawings, of which:

FIG. 1 is a high level block diagram of an example active data-aware storage system implementation;

FIG. 2 illustrates the mapper in more detail; and

FIG. 3 is a diagram illustrating an optional provisoner.

### DETAILED DESCRIPTION OF AN ILLUSTRATIVE EMBODIMENT

A particular embodiment includes an intelligence module and a mapper. The intelligence module has access to one or more data storage entities that ingest data in the form of data objects and/or data streams. The intelligence module collects real time intelligence by performing analytics on the data, such as its sensitivity, importance, activity history, and the like. The extracted analytics are then used to classify the data. Once classified, the mapper then uses one or more policies to assign an appropriate logical storage entity to subsequently handle the data.

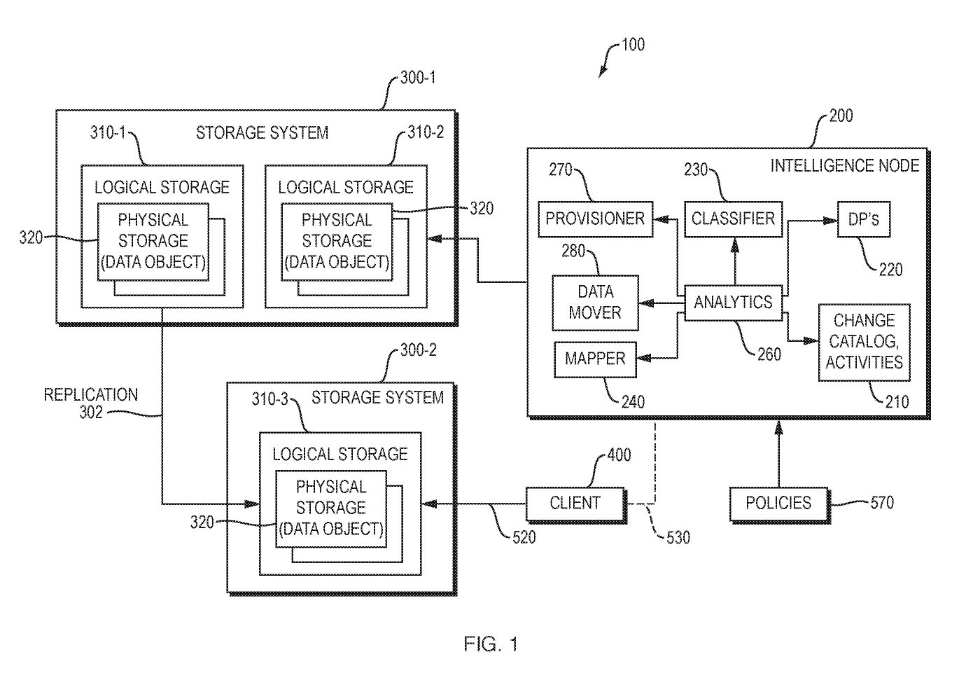

FIG. 1 illustrates an example system 100. Data objects and/or data streams are discovered and processed by an intelligence node or module 200. Typically, the data objects and/or data streams are stored in one or more storage systems 300-1, 300-2 (collectively, storage system 300) that include multiple logical storage sub-systems or logical storage entities 310-1, 310-2, . . . , 310-n. Each of the logical storage entities 310 encompasses one or more physical storage devices 320 that are responsible for storage access functions (including but not limited to primary storage access (file systems, block/file, protocols and the like), physical storage access (RAID, local/remote disk configuration), and other storage management functions stored in a primary pool. The logical storage entities 310 may also provide other functions such as data protection.

The storage system(s) 300 may provide information concerning the attributes of the various logical storage entities 310 (such as latency, sequential vs. random read/write performance, fragmentation, queue depth, cache size), as well as functional characteristics (backup frequency, replication, mean time between failure metrics, on-premesis or in-cloud, etc.) to be used by the intelligence node 200 as described in more detail below. In some implementations, the different storage systems may have different purposes or attributes. For example, if storage system 300-1 is performing as a primary data store, and storage system 300-2 performs replication 302 of the primary in storage system 300-1, storage system 300-2 may have different attributes and different types of logical storage entities 310-3 than the logical storage entities 310-1, 310-2 in storage system 300-1. In some implementations, the attributes of the logical storage entities 310 and storage systems 300 may be measured or otherwise inferred by the intelligence node.

The intelligence node 200 may be maintained and managed separately from the elements of the storage system(s) 300. That is, the logical storage entities 310 may be provided as stand-alone, on-premise storage sub-systems, storage networks, storage appliances, and the like, or may be provided as remote storage services such as public cloud (for example Amazon S3 or Rackspace) or private cloud storage services. However, in other embodiments, the intelligence node and storage system may be provided as a single integrated system that merges primary data storage, data protection, and intelligence functions as described in the co-pending U.S. patent application Ser. No. 14/499,886 referenced above. In such an integrated system, intelligence 200 is provided through in-line data analytics, and data intelligence and analytics are gathered on protected data and prior analytics, and stored in discovery points, all without impacting performance of the primary storage.

The intelligence module 200 maintains a change catalog 210, discovery points 220, and other information for data that it is responsible for. The intelligence module also includes additional functions such as analytics 260, a classifier 230, a mapper 240, and an optional provisioner 250, described in more detail below.

Regardless of how the logical storage entities 310 are provided, the notion is that the intelligence node 200 connects to each logical storage entity 310 to perform analysis 260 on the data stored therein. In some implementations, a client 400 may accesses the data to provide information (indirectly) about how often data is accessed, by whom, and so forth. Arrow 510 is to indicate that the intelligence node 200 extracts information about content from the data objects stored in the logical storage entities; the thinner arrow 520 indicates client 400 access of the objects, and may include explicit information about object usage. The dotted arrow 530 from client 400 to intelligence node 200 represents another embodiment wherein the client 400 sends access information directly to the intelligence node 200.

The intelligence node 200 may also captures data snapshots in the form of discovery points 220, and extract intelligence from the data in the logical storage entities 310 or the discovery points 230. The storage may also collect conventional input/output (I/O) characteristics as well as proprietary operational intelligence.

As used in this document, a data object is defined as any collection of data: a file, a directory, a set of files, a block, a range, an object, and so on. A data stream is any collection of events involving data objects; for example, a stream may be identified with a session (e.g., file open/close), a connection, a host, a user, an application, a file, a target, and so on.

The classifier 230 collects and analyzes whatever sorts of intelligence are presented by the analytics 260. The classifier 230 may include a plurality of classifier subsystems, each subsystem responsible for interpreting the available anayltics in a particular fashion, such as a subsystem that determines “importance” (as more fully explained below). For any given data object or data stream, the classifier 230 may output at least one labeled tuple of bounded integers, where the label identifies the a class for the data object or data stream, and the tuple encodes the analytics' 260 findings. A subsystem that determines importance might output a single tuple containing a single integer representing importance normalized to a range of 0 to 100, and this tuple would be labeled “importance.” These labeled tuples will be called attributes. A data class in this embodiment is then defined as an unordered set of attributes.

So defined, data classes can stand in set-theoretic relations to each other, where a superset is a subclass, a subset is a superclass, a union is a multiclass, and so on, along with the usual transitivity and associativity properties of such relations. Richer relations are possible by selecting or filtering on attribute labels. A practitioner of ordinary skill in the art will recognize that this definition facilitates a modest form of automated reasoning in the classifier 230, and will also recognize when to prefer a more expressive classification formalism, such as may be required by more powerful reasoning engines.

The classifier 230 may include, but is not limited to, subsystems that output attributes relating to importance, content types (for example “contains personally identifiable information”), access schedules, access locality, content types, and so forth. These will be described in greater detail below.

A classification strategy implemented by the analytics 260 and classifier 230 could be as simple as a static list of categories (i.e., the classifier's job is to decide which of several buckets each object belongs to), or it may be as complex as an entity-relationship model or a formal ontology (i.e., an ontology language like OWL is used to provide a set of nouns/nodes and verbs/edges, and the classifier's job is to summarize each object in terms of these descriptors).

Accordingly, an example classification strategy may be selected, under the following constraints:
1. The output of the classifier may be an enumerable entity that admits a well-defined association (or mapping) to a set of logical storage entities.
2. This logical storage entity (or its enumeration) thus mapped is suitable to store the data object and optional per-object metadata.

For example, a static classifier trivially satisfies these constraints, whereas a textual classifier that measures grammatical correctness would generally not be considered to have a well-defined mapping to any variety of storage services. The illustrative embodiment will disclose an example classification strategy.

The mapper 240 maps or associates a data class to a logical storage entity, which may be recursively represented as a tuple wherein each element is either a policy or a tuple. Policies 570 may include one or more protection policies, security policies, encryption policies, intelligence-related policies, caching policies, prefetching policies, and so on. Such a tuple may be construed as defining a data path or data flow through the components of the system, but this construal is limiting and the concept is more general: it may be any set of available polices that can be assembled, or can self-assemble, to map data objects to a logical storage entity. The mapper works on a “best fit” basis if it cannot find a logical storage entity that is an exact match to a policy.

A data class, being described as a set of attributes, is thus mapped to one or more logical storage entities 310 by piecewise mapping each attribute to one or more policies associated with that data class. The policies 570 that specify attribute mappings may be statically defined, obtained via input from a user via a graphical user interface, or dynamically defined.

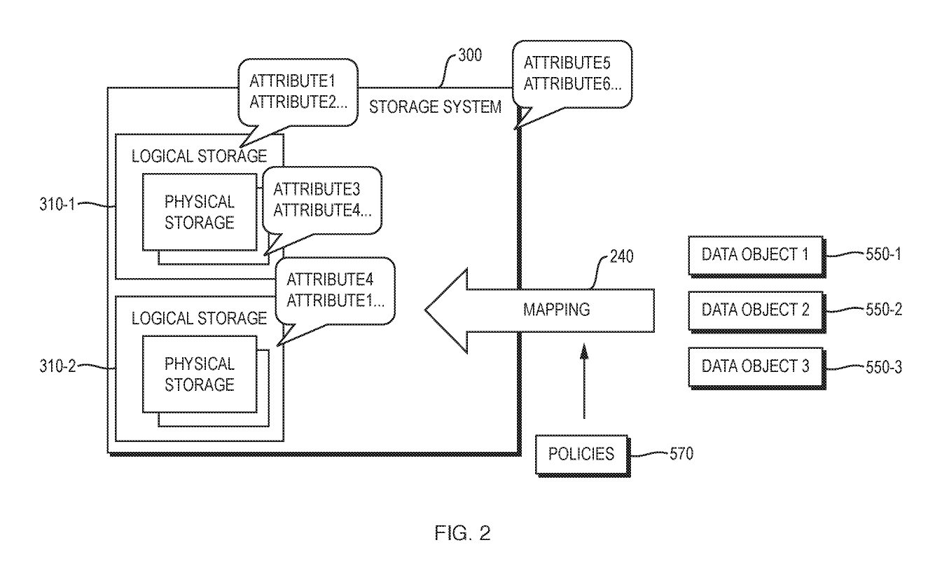

FIG. 2 shows selected components of the storage management system 100 annotated with attributes that are used by the mapper 240. Attributes may be configured or discovered. Attributes of the logical storage entities 310 may consist of the previously described performance characteristics as provided by the system 300 (latency, sequential vs. random read/write performance, fragmentation, queue depth, cache size), as well as functional characteristics (backup frequency, replication, mean time between failure metrics, on-premesis or in-cloud, etc.)

Once data objects 550-1, 550-2, 550-3 in the logical storage subsystem(s) 310 have had their content analyzed by analyzer 260, the mapper 240 is then used to implement the mapping from data objects 550 (which have their own properties) onto logical storage 310. Multiple logical storage entities 310 may satisfy the data-aware mapping constraints; the intent is to discover which have their constraints violated (or, requirements unmet).

Returning attention to FIG. 1, an optional data mover 280 may also be implemented as part of intelligence node 200. As explained above, when the classifier 230 initially encounters some data, it assigns a class, and the mapper 240 locates a logical storage entity 310 that is a best match for the policies associated with that class. The optional data mover can, on a scheduled basis, access-driven, or some other basis, encounter data that has been classed but is currently assigned to non-optimal storage. In addition, a change in content or format of data, or a change in policy, may have caused a subsequent change in optimal mapping. In such cases, data may again be submitted to analytics 260 and the classifier 230 which makes a subsequent determination of an appropriate class for the data. In the event that the class has not changed, then no action is needed. If however, the subsequent analysis of the data now shows different attributes indicating a different class, the assignment of this new class signals a mismatch between the object's class and the logical storage entity in which it currently resides. If the object's new class now better maps to an entirely different storage entity 310, then the data mover 280 moves the data to the more appropriate location.

It may also be the case that the storage management system does not have control over where the data is initially placed. So it may be the case that data is initially found in the wrong type of storage entity. In that case, the data mover 280 may also be used to ensure that a class is determined for the data, and an appropriate storage entity mapped.

Once the mapper 240 (and/or data mover 280) finds policy violations, it may suggest or even automatically implement repair actions that can be undertaken, or interact directly with the storage system 200 to enact repair. Schedule-driven prefetching of data for possible repair action, such as warming caches by pre-reading data, is another possible repair action.

In one simple example, a policy may specify that an importance attribute in the range of 75-100 is preferentially mapped to a high-reliability logical storage. Even this relatively simple mapping scheme can express a rich concept: “a high-importance low-performance text document is preferably mapped to a storage entity comprising on-premises HDDs (physical storage policy), triple parity RAID (high-reliability low-performance policy), and a demand prefetch cache (text document policy)”

The mapper 240 can also express negative assertions. In one example, defining a “don't cache streaming reads” policy 570 may specify that data objects belonging to a “streaming read” superclass may simply be mapped to a storage entity 310 that has no cache.

Some other examples of polcies might include:
“personally identifying information (PII)” MUST be stored on “encrypted” and MUST NOT be on “public” storage
“high bitrate” data SHOULD be stored on “high throughput” storage
“stream” data SHOULD be stored on “sequential access” storage
“random access” data SHOULD be stored on “cached” storage
“random access” data SHOULD be stored on “low latency” AND “random access” storage
“important” data MUST be stored on “offsite replicated” storage and SHOULD have “daily backups”
“routinely used” data SHOULD be stored on “prefetchable” storage

As mentioned above, it is also possible to operate on tuples or sets of policies. For example,
“personally identifying information” is “important”
“owned by members of Finance” is “important”

An audio file that is owned by the CFO that mentions client's street address and birthday could be analyzed to have a set of attributes including “PII”, “important”, “owned by Finance”, “streamed”.

Policies may also specify logical storage choices based on their physical characteristics. For example, a certain logical storage entity 310 may included a replicated HDD RAIDS array or an all SSD datastore, and the mapper could choose to assign the file to the HDD array because it meets more of the requirements in the policies.

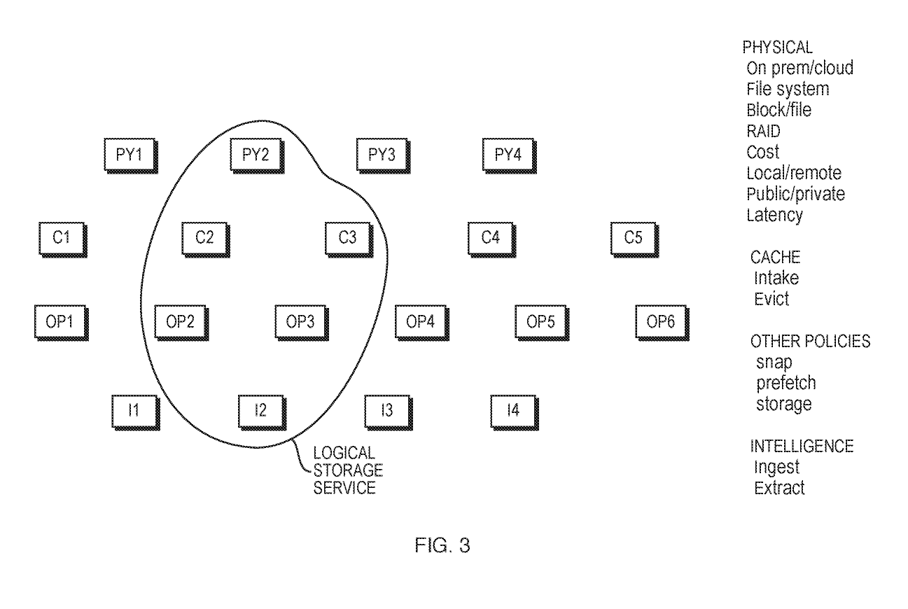

From the discussion above, it is understood that the system both (a) maps a set of policies to a logical storage entity, and (b) maps a data class to storage entities. FIG. 3 illustrates an example tuple that defines a mapping of a particular set of policies to actively define a storage service based on the collected intelligence. Each block in the diagram represents a different instance of a policy. For example, the blocks labeled PY represent different available physical storage policies mentioned elsewhere. One PY block may represent a particular HDD type; another PY block may represent a data layout paradigm, and another PY block a set of RAID parameters (level, chunk size, write size). Blocks labelled C represent different available caching policies (one block C representing a cache intake policy and another a cache device property); blocks OP represent other policies (e.g., protection policies, security policies, prefetching policies, snapshot policies, etc.); and blocks labelled I represent intelligence-related policies.

In the particular example of FIG. 3, a set of policies PY2, C1, C2, OP3, OP4 and I2 are grouped as a tuple to define a particular logical storage service SS.

If a precise logical storage entity 310 is not already available to the system 100, the optional provisioner 270 (FIG. 1) may attempt to provision it—typically at least by coordinating the provisioning within a primary storage pool available to it. It may also attempt to select a best match from whatever services have been provisioned. The best match may be defined as a piecewise match, so that for each desired policy type (e.g., physical storage), the provisioner 270 may thus select the closest matching policy (e.g., a SAS 12 Gb/s HDD is desired but only a SAS 6 Gb/s HDD is available). Or, the best match may be defined as a minimum distance match across all desired policies at once (e.g., a RAID-6 on SAS 12 Gb/s is desired, so select RAID-6 on SAS 6 Gb/s rather than RAID-5 on SAS 12 Gb/s).

### Classifier 230

The classifier 230 subsystems are now described in further detail.
A. Subsystems related to activity history. The intelligence module 200, in some embodiments, may tracks and stores every operation on every file (read, write, modify, rename, delete, etc.), along with the user that performed that operation. This information may be maintained in the change catalog 210 or elsewhere. The classifier 230 may thus have access to the entire history of every object, which enables rich classification strategies that include, but are not limited to:
   1. Schedule discovery subsystem. Activity lists are uniquely suited to detecting access patterns that occur relative to absolute time. For example, the classifier may search for predefined patterns, such as “6 am weekday” or “first day of the month”. Or, the classifier may infer a novel pattern from analysis, such as “every Saturday at 8 am and 6 pm”
   2. A pattern may be encoded as an attribute labeled “absolute schedule,” each containing ten integers representing five ranges: the time of day, the days of the week, the weeks of the month, the days of the month, and the months of the year. An empty range (0,0) is interpreted nonrestrictively, i.e., if a day is unspecified, then access occurs every day. Discontinuous ranges, such as “Tuesdays and Thursdays” may be represented by outputting multiple attributes.
   3. Locality discovery subsystem. Activity history may reveal groups of objects that are frequently accessed together. Suppose the classifier has newly identified one such group, and call this G. G may be ordered or unordered. Being unsuitable for encoding as an attribute, G is saved in the classifier as global metadata, and assigned an integer group ID. The objects that belong to G each receive an attribute labeled “locality group,” containing the group ID.
      Importantly, activity history also reveals when group associations change or cease. The single instance of G stored in the classifier is then easily updated.
   4. Dormant data subsystem. One aim may be to do away with imprecise notions of “hot” and “cold” data. It may seem that truly cold data needs no further classification with regard to behavior (though it may still be classified according to importance and compliance), but the system may positively identifying coldness by classifying activity, rather than negatively inferring coldness by lack of activity, as commonly practiced. Cold data may be subject to vigorous backup or virus-scanning activity that would defeat any attempt to detect coldness by negative inference. Advantageously, the system can positively define and detect a cold data object as one whose activity comprises only backups, scans, migrations, and so on. This subsystem signifies such objects with an attribute labeled “dormant” containing an empty tuple.
B. Content identification subsystem. The classifier 230 also preferably extracts content from data objects and/or data streams. It can recognize the internal structure of any number of known data formats, including but not limited to documents, media, databases, and containers such as virtual machines. Such content may be indexed, interpreted, organized, searched, monitored, and otherwise processed into forms and structures amenable to classification. Examples include:
   1. An object may be identified as a specific format (e.g., a SQLite database). Each known format is assigned a well-known ID. The classifier 230 subsystem then outputs an attribute labeled “object format,” containing the format ID.
   2. An object may be identified as one of many formats that all belong to the same category (e.g., all types and vintages of Microsoft Office files). The category is assigned a format ID no different from a singular format, so the attribute is also no different.
   3. An object may contain metadata that directly informs its classification (e.g., a media file that specifies its own streaming bit rate). The classifier 230 may output additional attributes alongside the object format, e.g., an attribute labeled “streaming bit rate” containing the detected bit rate normalized to kilobits per second.
   4. An object may also be characterized according to other properties relevant to ensuring that regulatory or administrative requirements are met. For example, a data object may receive an attribute based on whether its owner is or is not a member of a certain group of administrative users
C. Importance quantification subsystem. A classifier 230 may determine importance in various ways, including but not limited to:
   By explicit assignment (path, directory, share, user, type)
   By positive or negative pattern match on identity (pathname, directory name, share name, user name, type name)
   By positive or negative pattern match on content (keywords, search expressions, personally identifiable information, Social Security numbers, credit card numbers, etc.)
   By semantic content (statistical linguistics, natural language processing)
   By similarity to other important files (e.g., by common keywords)
   By design (e.g., predefined rules that promote filesystem metadata and demote swap files)
   By boolean combinations of the above (e.g., pathname AND username)
   By linear combinations of the above (e.g., the same file may be promoted by the username “CEO” but simultaneously demoted by the extension “tmp”)
   These may be summarized into an overall attribute labeled “importance,” containing a tuple of integers normalized to a range such as from 0 to 100, representing the various individual attributes.
D. IO Metrics Subsystem. The classifier may also track conventional IO characteristics (if made available by the logical storage entity or discovered by the classifier 230):
   Queue depth
   IO size and alignment
   Sequential streaming
   Random access
   Cache hits, misses, residency time
   Fragmentation
   Contention
   Used space, free space
      These metrics may be encoded as a tuple of integers labeled “IO metrics.” Explicit hinting may be supported by allowing an application (such as an application running on client 400) to directly suggest attributes for a given data object. Declarations of application intent may be represented as absolute schedule attributes, locality group attributes, or IO metrics attributes (e.g., random access). In particular, a type of absolute schedule attribute may be a single future predicted access. The hinting application may be the intelligence module itself, declaring the set of unprocessed objects that it expects to process next.

### Policies 570

To further elaborate on the above description, the policies may include:
Caching policies. Even a relatively simple storage system may offer a wide range of storage services differentiated by cache behavior alone.
   Cache intake policies dictate whether or not data gets cached, and where.
   Cache eviction policies dictate what happens once data is in cache, and
      where it goes when it leaves.
         Common eviction policies include LRU, MFU, ARC, and round-robin.
         Novel eviction policies might include, “evict object after one access.” This would be appropriate for objects belonging to the “Microsoft Office document, superclass, which are always read in their entirety and never modified in-place.
         Absolute schedule eviction would demote associated data after a specific date or time has passed.
   Cache device policies. A system may have several caches with diverse hardware and software properties, instead of (or in addition to) a hierarchical level 1/level 2/ . . . / level N arrangement.
Prefetching policies.
   Demand prefetch: Conventional prefetching attempts to predict what objects benefit from prefetching, such as by detecting streaming reads in progress. Here, this task may be handled by the classifier, avoiding false positives that waste cache space. A storage service employing this policy will prefetch the whole of any object accessed in part, provided that the object belongs to an appropriate class or superclass, i.e., the class has a relevant attribute such as “sequential streaming” or “Microsoft Office document” (the latter being synergistic with an “evict after one access” policy).
   Absolute schedule prefetch. A storage service employing this policy will prefetch any object owned by that service according to that object's “absolute schedule” attributes, if the object has any. If the schedule specifies a duration, then the object may be evicted according to that schedule as well.
   Locality prefetch. A storage service employing this policy will prefetch the whole of a locality group whenever accessing any part of that locality group. Moreover, whenever such files also have similar eviction behavior, then batch prefetching also improves spatial locality within the cache, which in turn improves cache fragmentation.
Physical storage policies. The purpose of a physical storage policy is to represent the physical characteristics of the available storage devices (hardware or virtual) during mapping, and to govern allocation (if necessary) during optional provisioning. Accordingly, any device that has meaningfully distinct consequences for some data class will appear as an available policy:
   HDD types: high-performance, nearline, low power, zoned (shingled) access
   SSD types: to provide more granularity than merely read-intensive vs. write-intensive, it is possible for each SSD model to appear as a separate policy advertising the exact capacity, performance, and endurance of that model
   Cloud storage types: local-area, metropolitan-area, wide-area
   Tape
Logical storage policies include various data stores (file, block, object) of various types (write-in-place, copy-on-write, cloud). They can also include generic metrics such as free space (absolute or percent).
Compression policies: object compression, block compression, or no compression
Redundancy policies encompass RAID and mirroring options, but may also include uncommon options such as cloud redundancy:
   RAID: Any RAID level and chunk size is available as a policy option, including triple parity or greater redundancy
   Mirroring: Any level of mirroring redundancy and chunk size is available as a policy option
   Erasure coding: Information dispersal across nodes or clouds
   Cloud: No local redundancy after being backed up in cloud
Security policies, such as:
   Authentication methods
   Encryption policies, such as object encryption, drive encryption, network encryption
Protection policies. This encompasses backup, restore, availability, reliability, and replication. A very important file may also be a cold file. Yet, it may be very important for that file to have either excellent protection or excellent performance, or both.
   Important files should get priority in replication, in content extraction, in flushing, in backup, and especially in restore. Assuming that bad things can happen during a restore, clearly the most important files must be restored first.
   Important files might deserve extreme protection, such as provisioning a triple-parity RAID target or maintaining copies in more than one cloud.
   Similarly, unimportant files should be processed last in any situation.
Intelligence-related policies. Intelligence-related policies may also be specified. For example, upon initial ingest of data, there may be a need to have a storage policy based on the available rapid access time, indexing method, what data to extract, prioritizing ingest over other functions, snapshot policy and so forth. More generally, these policies may be based on any metric relevant to converting the original data object or stream into intelligence. An intelligence policy may be further associated with a particular user (or process) related to the data object or stream. An intelligence policy may also be applied differently for later consumption than it was for the initial ingest. The same data object or data stream may traverse a different storage service in the customer-directed primary module IO path than for the intelligence module. In one example, a storage service for primary access may specify SSD's, with intelligence access specifically not provisioning a storage service with SSD, because the analysis will not be performed until some time later.

### FURTHER EXAMPLES

Additional examples demonstrate how analytics-derived data classification is used to select a logical storage entity for handling data.

In one specific example, the classifier 230 may encounter a medical dictation audio file, and assigns a data class comprising these attributes: MP3 audio file, HIPPA-level security, importance level 90, sequential access, two accesses per week. This class would be mapped to a logical storage entity as a result of mapping these policies: copy-on-write file store (mapped from MP3), no compression (mapped from MP3), object encryption (mapped from HIPPA), drive encryption (mapped from HIPPA), RAID with triple parity (mapped from importance), demand prefetch (mapped from sequential streaming). If this exact logical storage entity is not available in the system 100, the mapper finds the closest match.

In another example, the classifier 230 encounters the medical dictation file again as part of scheduled or some other subsequent analysis of data that has previously been classified. However, based on new information from the intelligence module 200, the classifier 230 removes the attribute “two accesses per week” from the object's class and assigns the attribute “dormant.” The assignment of this new class signals a mismatch between the object's class and the logical storage entity in which it currently resides; the object's new class now maps to an entirely different storage entity comprising: cloud file storage, object encryption, no compression. The data mover 280 thus periodically attempts to move these now mismatched objects to their appropriate storage entity. In some instances, the data mover may invoke provisoner 270 for provisioning a new storage entity if indicated and if available.

In another example, the classifier 230 determines that groups of files are always accessed together, which become identified as locality groups. The “locality prefetch” policy thus functions as a content-aware prefetch service. So a storage entity 310 can be mapped such that every time someone accesses file #1, we will also prefetch files #2 through #50. This is possible because accessing any object also fetches that object's data class; if the object belongs to a locality group, its class will contain a locality attribute that contains the locality group ID. The function of the “locality prefetch” policy is to extract the locality group ID from any object access, ask the classifier 230 for the full list of objects in that locality group, and then prefetch all of those objects.

Each logical storage entity may also be defined by a set of one or more policies (physical, caching, intelligence, or other policies). The storage service definitions may be associated with a user or process that provides the data as input—thus optimizing the assignment of a storage class based on user identity. In one example, if the classifier 230 knows from past history that a particular user is data intelligence intensive, and that user typically needs access to the data immediately, the provisioner can also assign an appropriate cache policy.

In another example, the policies may be defined for two types of caches (say, Least Recently Used and Most Recently Used). In this example, the desire to forward data objects or data streams to one or the other cache type may be accomplished by mapping logical storage entities with one or the other cache policy, and storing each object in its desired storage service. The mapping of each object's class to its desired storage may be based on some other policy or group of policies or groups of other attributes derivable from the data object or data stream.

A further example could provide optimized storage based on file type. In one example the system may be asked to ingest a large number of video files with a high streaming rate. For a video file with a high streaming rate, a logical storage entity with a relatively large RAID chunk size may be desirable for initial ingest. While this is extremely good for video streaming, it may be quite bad for a lot of other things—such as frame-by-frame image pattern recognition processing. The system can thus dynamically adjust, mapping to the larger RAID chunk size for initial ingest, and mapping a smaller RAID stripe size for later intelligence. In another example with video files, the system may determine that it is better to store video files on small, slow, legacy HDD's rather than faster HDD's or SSD.

Another example can optimize for backup processing. The system might default to keeping backups for three (3) weeks. But based on intelligence data, it appears that many users are actually reviewing files in the backup even on the very day they are deleted. Upon detecting this pattern, the system may decide to modify an object's data class to signify a backup retention of six (6) weeks instead of three. Thus a storage class having a particular backup (retention) policy may be mapped to a certain logical storage entity 310 based on actual activity. The object's new data class maps to a logical storage entity that is completely identical to the object's old storage entity except for a new backup policy. Since the new storage entity does not physically differ from the prior one, the new storage entity preferably reuses the underlying resources already allocated, and the object preferably remains without undergoing a physical migration. More generally, a system that has many hundreds of available logical storage entities does not necessarily need to have many hundreds of, say, physical filesystem instances.

In another example, intelligence may determine the data object is a large file that should be prefetched—but that only the intial part is accessed sequentially by the user, and other parts randomly. For example, the file may be a large text file for which only the first 10 pages ever get read on a regular basis. Thus the storage class appropriate for this file may define that the initial parts of the file are stored on a logical storage entity optimized for sequential access, and other parts on a logical storage entity optimized for random access. To be more specific, when data extraction is performed in the intelligence phase, the system can index the file to determine where the section titles are, and then create a policy that prefetch is only performed up to byte number “x”. In yet another example, a database having content related to personal data for a large number persons may be defined by database keys. If the application is using the database for facial recognition pattern, the policy may specify only prefetching records for first persons named “Bob” when “we are only looking for someone named Bob”. . . .

It should be understood that the storage services, when provisioned 270, can be provisioned in advance, or “on the fly” in response to real-time intelligence.

What is claimed is:

1. A system comprising:
an intelligence module, for performing analytics on data and assigning a data classification for the data using the analytics;
a plurality of logical storage entities, at least two of the logical storage entities having different attributes from one another; and
a mapper, for using one or more policies associated with the data classification to assign one of the logical storage entities for storing the data, the assigned logical storage entity having attributes that are a best fit to the one or more policies.

2. The system of claim 1 wherein the data classification depends on at least one of (a) content of the data or (b) how the data is encoded.

3. The system of claim 1 wherein the policies include security policies, protection policies, prefetch policies, and performance policies.

4. The system of claim 1 additionally comprising:
storing the data in the assigned logical storage entity.

5. The system of claim 1 wherein the attributes of the logical storage entities are selected from a group consisting of public cloud, private cloud, local storage, and on-premises storage.

6. The system of claim 1 wherein the attributes of the logical storage entities are selected from a group consisting of redundancy, latency, speed, cost, security, encryption, cache type, access type, solid state or magnetic.

7. The system of claim 1 wherein the intelligence module assigns a restricted data classification to the data, and a least one policy is to prevent movement of restricted data to a logical storage entity that has a public cloud attribute, and another policy is to enforce encryption of the data.

8. The system of claim 1 wherein:
the intelligence module further performs subsequent analytics that reclassify the data; and
the mapper assigns a different one of the logical storage entities for storing the data having attributes that are a best fit to the one or more policies associated with the subsequent analytics.

9. The system of claim 1 wherein the attributes of at least one of the logical storage entities are discovered by the intelligence module.

10. The system of claim 1 wherein the data classifications are selected from a group consisting of importance, protected content, file type, media file quality, executable, and access patterns

11. The system of claim 1 wherein the intelligence module performs subsequent analytics on the data subsequent to it being stored in one of the logical storage entities, and further comprising:
a data mover, for moving data to a different one of the logical storage entities based on the subsequent analytics.

12. The system of claim 1 additionally comprising:
a provisioner, for provisioning one of the logical storage entities to have selected attributes based on the analytics.

13. A method comprising:
performing analytics on data and assigning a data classification for the data using the analytics;
storing data among a plurality of logical storage entities, at least two of the logical storage entities having different attributes from one another; and
mapping data to the logical storage entities using one or more policies associated with the data classification, to thereby assign one of the logical storage entities for storing the data, the assigned logical storage entity having attributes that are a best fit to the one or more policies.

14. The method of claim 13 wherein the data classification depends on at least one of (a) content of the data or (b) how the data is encoded.

15. The method of claim 13 wherein the policies include security policies, protection policies, prefetch policies, and performance policies.

16. The method of claim 13 additionally comprising:
storing the data in the assigned logical storage entity.

17. The method of claim 13 wherein the attributes of the logical storage entities are selected from a group consisting of public cloud, private cloud, local storage, and on-premises storage.

18. The method of claim 13 wherein the attributes of the logical storage entities are selected from a group consisting of redundancy, latency, speed, cost, security, encryption, cache type, access type, solid state or magnetic.

19. The method of claim 13 wherein the analytics determines a restricted data classification for the data, and a least one policy is to prevent movement of restricted data to a logical storage entity that has a public cloud attribute, and another policy is to enforce encryption of the data.

20. The method of claim 13 additionally comprising:
performs subsequent analytics that reclassifies the data; and
assigning a different one of the logical storage entities for storing the data having attributes that are a best fit to the one or more policies associated with the subsequent analytics.

21. The method of claim 13 wherein the attributes of at least one of the logical storage entities are discovered by the intelligence module.

22. The method of claim 13 wherein the data classifications are selected from a group consisting of importance, protected content, file type, media file quality, executable, and access patterns

23. The method of claim 13 additionally comprising:
performing subsequent analytics on the data subsequent to it being stored in one of the logical storage entities, and
moving the data to a different one of the logical storage entities based on the subsequent analytics.

24. The system of claim 13 additionally comprising:
provisioning one of the logical storage entities to have selected attributes based on the analytics.
